(19) United States
(12) Patent Application Publication
(10) Pub. No.: US 2016/0194551 A1
(43) Pub. Date: Jul. 7, 2016

(54) METHOD FOR REMOVING BITUMEN TO ENHANCE FORMATION PERMEABILITY

(71) Applicant: SCHLUMBERGER TECHNOLOGY CORPORATION, Sugar Land, TX (US)

(72) Inventors: George WATERS, Oklahoma City, OK (US); Richard LEWIS, Longmont, CO (US); Erik RYLANDER, Frisco, TX (US); Andrew E. POMERANTZ, Lexington, MA (US); Ridvan AKKURT, Lexington, MA (US); Roderick BOVEE, Somerville, MA (US); Syed A. ALI, Sugar Land, TX (US)

(21) Appl. No.: 14/910,615

(22) PCT Filed: Aug. 7, 2014
(86) PCT No.: PCT/US2014/050082

§ 371 Date: Feb. 5, 2016

Related U.S. Application Data
(60) Provisional application No. 61/863,208, filed on Aug. 7, 2013.

(51) Int. Cl. C09K 8/64; E21B 43/26; E21B 43/16; C09K 8/70; C09K 8/58

(52) U.S. Cl. CPC C09K 8/64; C09K 8/703; C09K 8/58; E21B 43/16; E21B 43/26

(57) ABSTRACT

Treatment methods and treatment fluids for increasing permeability of organic shale formations are described herein. The treatment method includes treating an organic shale formation with a treatment fluid. The treatment fluid includes a solvent that dissolves bitumen in the shale formation. After treating the shale formation with the treatment fluid, oil is recovered from the shale formation. By removing bitumen from pores and pore throats within the formation, the solvent increases permeability of the formation and allows mobile oil to flow more easily through the formation.

### PRIORITY

The present application claims the benefit of U.S. Application Ser. No. 61/863,208 filed Aug. 7, 2013, which application is incorporated herein, in its entirety, by reference.

### TECHNICAL FIELD

This disclosure relates to hydrocarbon recovery from formations. In particular, this disclosure relates to treating formations to enhance formation permeability.

### BACKGROUND

Hydrocarbons, such as oil and gas, are produced from subterranean formations. The formations include many pores that include hydrocarbons. The hydrocarbons are recovered by drilling a wellbore that traverses the subterranean formation. The hydrocarbons migrate through connected pores and fractures within the subterranean formation and into the wellbore, where they travel to the surface. Generally, the more permeable a formation is, the more easily the hydrocarbons pass through the formation and into the wellbore. Conventional reservoirs are relatively permeable so hydrocarbons pass more easily into the wellbore. However, unconventional reservoirs, such as organic shale formations, are less permeable. In particular, organic shale formations include immobile organic matter that can block the flow of hydrocarbons between and through pores within the formation.

### SUMMARY

Illustrative embodiments of the present disclosure are directed to methods for treating an organic shale formation to increase permeability. The method includes treating a portion of the shale formation with a treatment fluid. The treatment fluid is transported to the portion of the shale formation using a wellbore that traverses the formation. The treatment fluid includes a solvent that dissolves bitumen in the shale formation and increases permeability of the shale formation.

After treating the shale formation with the treatment fluid, oil is recovered from the shale formation. The treatment method can be part of a hydraulic fracturing operation, an enhanced oil recovery operation (EOR), or a remedial treatment. In various embodiments, the treatment of the formation extends into a far-wellbore zone of the shale formation (e.g., 100 meters).

In illustrative embodiments, the solvent includes one or more of the following chemicals: a limonene-based solvent, a pinene-based solvent, cyclohexanone, N-methylpyrrolidinone, an aromatic fluid, a dialkyl ether, an alkylated fatty acid, a fatty acid alkyl ester, an alkenoic acid ester, and/or 2-methyltetrahydrofuran.

### BRIEF DESCRIPTION OF THE DRAWINGS

Those skilled in the art should more fully appreciate advantages of various embodiments of the disclosure from the following “Description of Illustrative Embodiments,” discussed with reference to the drawings summarized immediately below.

FIG. 1 shows a method a method for treating an organic shale formation to increase permeability in accordance with one embodiment of the present disclosure;

FIG. 2 shows a hydraulic fracturing operation in accordance with one embodiment of the present disclosure;

FIG. 3 shows a plot of efficacy of various treatment fluids, composed of pure solvents, in dissolving bitumen in organic shale formation samples, in accordance with various embodiments of the present disclosure;

FIG. 4 shows a plot of absorbance for treatment fluids, composed of surfactants with different hydrophilic-lipophilic balance values, after exposure to organic shale formation samples in accordance with various embodiments of the present disclosure;

FIG. 5 shows a plot of absorbance for treatment fluids, composed of a solvent and a combination of two surfactants at different ratios of the two surfactants, after exposure to organic shale formation samples in accordance with various embodiments of the present disclosure;

FIG. 6 shows a plot of absorbance for treatment fluids, composed of emulsions with different solvent-surfactant ratios, after exposure to organic shale formation samples in accordance with various embodiments of the present disclosure;

FIG. 7 shows a plot of absorbance for treatment fluids, composed of emulsions with varying salinity, after exposure to organic shale formation samples in accordance with various embodiments of the present disclosure;

FIG. 8 shows a plot of absorbance for treatment fluids, composed of emulsions with varying methanol content, after exposure to organic shale formation samples in accordance with various embodiments of the present disclosure;

FIG. 9 shows a plot of absorbance for treatment fluids, composed of emulsions with varying isopropanol content, after exposure to organic shale formation samples in accordance with various embodiments of the present disclosure; and

FIG. 10 shows a plot of absorbance for treatment fluids, composed of solvent-solvent mixtures, after exposure to organic shale formation samples in accordance with various embodiments of the present disclosure.

### DESCRIPTION OF ILLUSTRATIVE EMBODIMENTS

Definitions. As used in this description and the accompanying claims, the following terms shall have the meanings indicated, unless the context otherwise requires:

A “organic shale formation” is a formation that includes kerogen, bitumen, and oil. The porosity and the permeability of organic shale formations are often low with values typically less than 10 pu and 1 uD, respectively.

“Kerogen” is an organic solid material that is insoluble in organic solvents.

“Bitumen” is an organic, immobile, and highly viscous substance that is soluble in organic solvents.

An “oil” is a liquid hydrocarbon that is mobile (without obstruction) under natural temperature and pressure conditions within a formation.

A range “from X to Y” includes the values of “X” and “Y.” The ranges stated herein should be interpreted to include boundary values.

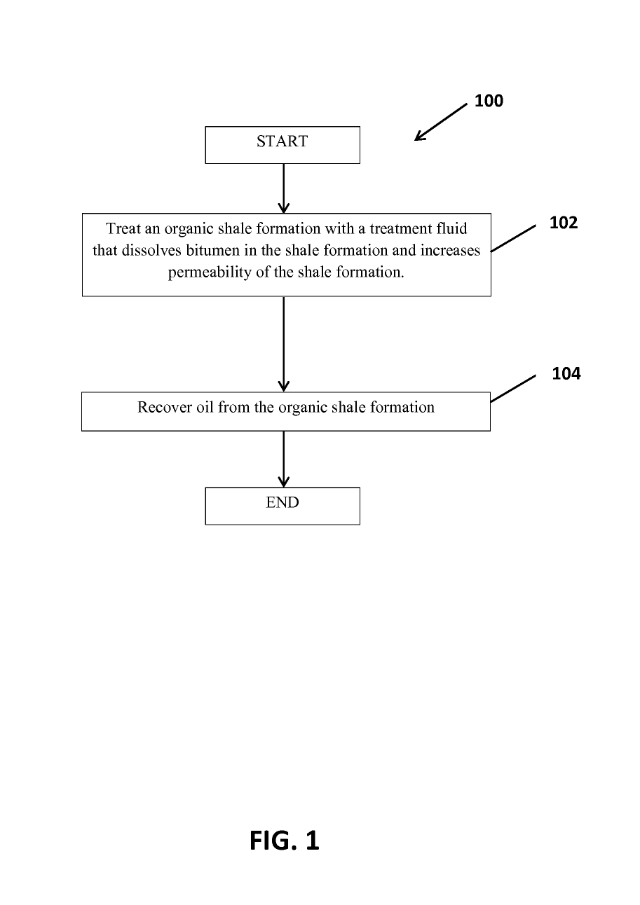

Illustrative embodiments of the present disclosure are directed to methods and treatment fluids for treating an organic shale formation to increase permeability. FIG. 1 shows an example of the method 100. At process 102 of the method, an organic shale formation is treated with a treatment fluid. The treatment fluid is transported to a portion of the shale formation using a wellbore that traverses the formation. The treatment fluid includes a solvent that dissolves bitumen in the shale formation and increases permeability of the shale formation. After treating the shale formation with the treatment fluid, at process 104, oil is recovered from the shale formation. By removing bitumen from pores and pore throats within the formation, the solvent increases permeability of the formation and allows mobile oil to flow more easily through the formation. Details of illustrative embodiments are provided below.

The treatment fluid can have one or more components with different concentrations. For example, in one embodiment, the treatment fluid is composed of a pure solvent (e.g., 100% concentration) or a combination of two or more solvents. In another embodiment, the treatment fluid is composed of one or more solvents and one or more other components. The concentration of the solvent within the treatment fluid can vary from 0.01% to 100%.

Various different types of solvents can be used to dissolve bitumen within the organic shale formation. For example, the solvent can be a terpene-based solvent. More specifically, the terpene-based solvent is a limonene-based solvent (e.g., d-limonene) and/or a pinene-based solvent (e.g., turpentine). Many terpene-based solvents are biodegradable. The solvent may also be cyclohexanone, N-methylpyrrolidinone, an aromatic fluid, a dialkyl ether, an alkenoic acid ester, 2-methyltetrahydrofuran, an alkylated fatty acid, and/or a fatty acid alkyl ester (e.g., biodiesel, methyl caprylate/caprate, methyl laurate, methyl myristate, canola methyl ester, soya methyl ester, methyl and/or palmitate/oleate). The solvent may include a combination of two or more of the components listed above in this paragraph. In various embodiments, xylene is not used as a solvent.

As explained above, the treatment fluid can include one or more other components. For example, the treatment fluid may include a diluent, such as water or a gas-based foam. The gas-based foam can include nitrogen, carbon dioxide, methane, and/or propane. The solvent is diluted within the diluent.

In embodiments where the diluent is water, a surfactant can be used to create an emulsion between the water and the solvent. The emulsion is used to make a stable mixture of the solvent and the water. The surfactant can be a nonionic ethoxylated surfactant that includes (i) an alcohol, (ii) an octyl-phenol or nonylphenol, (iii) a sorbitan fatty-acid ester, and/or (iv) a fatty acid. Alternatively or additionally, the surfactant can be an anionic surfactant, such as an alkyl sulfate, a dialkyl sulfosuccinate, and/or a linear alkyl benzene sulphonate. In some embodiments, the solvent is emulsified within the water (where water is the external phase). In other embodiments, the water is emulsified within the solvent (where solvent is the external phase).

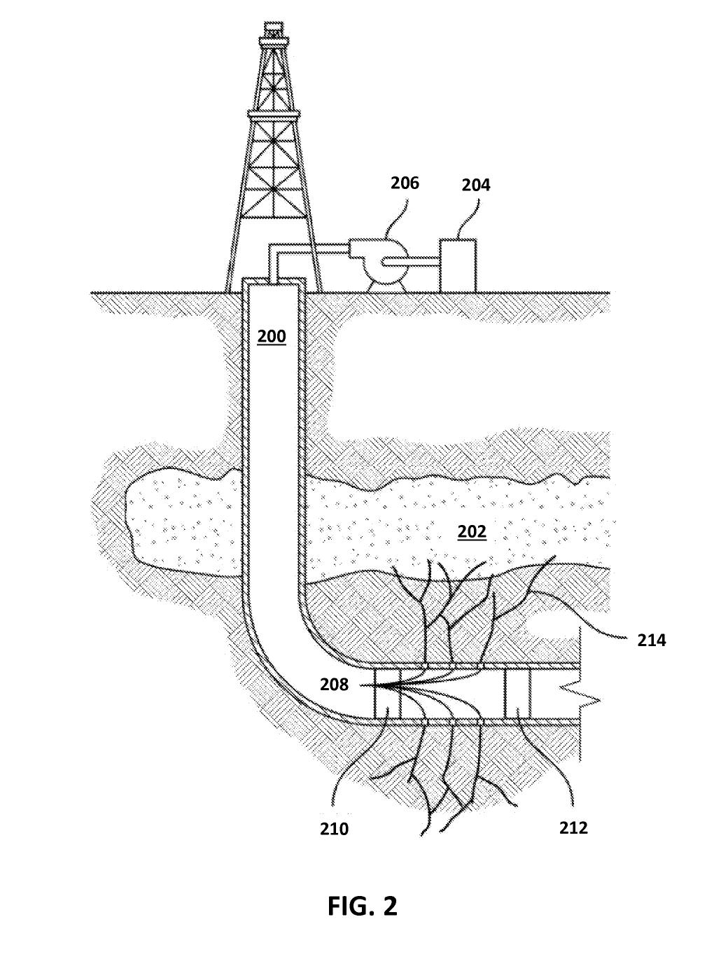

Various embodiments of the treatment methods and treatment fluids described herein have application in hydraulic fracturing operations. FIG. 2 shows a hydraulic fracturing operation in accordance with one embodiment of the present disclosure. The hydraulic fracturing operation is performed in a production wellbore 200 that traverses an organic shale formation 202. The fracturing operation is performed by pumping a treatment fluid (liquid, gaseous, or a combination) into the wellbore from a surface reservoir 204 using a pump 206. The treatment fluid communicates with the formation through a series of perforations 208. In other embodiments, the treatment fluid communicates with the formation through port collar opening devices or through injection into uncased open-hole intervals. The treatment fluid may be hydraulically confined to a particular portion of the wellbore by using packers (210 and 212). For example, if the wellbore includes a completion with packers, then some or all of the perforations 208 in a particular area may be hydraulically isolated from other portions of the wellbore so that the fracturing is performed on a particular portion of the shale formation 202. In order to implement the fracturing operation, the pressure of the treatment fluid is increased using the pump 206. The communication of that increased pressure to the shale formation 202 creates new fractures and widens existing fractures (collectively, fractures 214 in the formation).

The treatment methods and treatment fluids described herein can be used to further enhance permeability of the organic shale formation 202 during the hydraulic fracturing operation. In one such embodiment, the solvent is a component of the treatment fluid (e.g., hydraulic fracturing fluid). In various embodiments, the concentration of the solvent within the treatment fluid is from 0.01% to 5.0%. In one embodiment, the solvent is emulsified in an aqueous treatment fluid using a surfactant. The solvent flows into the fractures 214 of the formation and/or the solid matrix 202 of the formation and dissolves bitumen within the fractures, pore throats, and/or pores of the shale formation. The treatment fluid then flows back from the formation 202 and into the wellbore 200. As the treatment fluid flows back into the wellbore 200, the fluid carries the dissolved bitumen with it. By removing a portion of the bitumen, the solvent within the treatment fluid enhances the permeability of the shale formation 202. Additionally or alternatively, a treatment fluid with the solvent can be used as a spearhead fluid. Spearhead fluids are used to treat the shale formation 202 prior to performing the main fracturing treatment and to remove perforation debris from the near-wellbore zone.

Various embodiments of the treatment method and treatment fluids described herein also have application in other oilfield operations. For example, the treatment fluids can be used as part of an enhanced oil recovery (EOR) operation. In an EOR operation, a treatment fluid is injected through an injection wellbore and into the organic shale formation. The treatment fluid passes through the shale formation and is recovered at a production wellbore. The treatment fluid flushes out oil in the formation and facilitates movement of the oil through the formation and into the production wellbore. The solvent may be a component of the treatment fluid (e.g., EOR fluid) used to recover oil. In illustrative embodiments, the concentration of the solvent within the EOR treatment fluid is from 0.01% to 100%. In a more specific embodiment, for a solvent in water emulsion, the combination of the surfactant and the solvent has a concentration from 5% to 10%. In other embodiments, the EOR operation can be performed only in the production wellbore. The treatment fluid is injected into the production wellbore and into the shale formation. Then, after a time period that allows the treatment fluid to dissolve bitumen, the treatment fluid is pumped back to the production wellbore.

In another example, the treatment fluids described herein can be used as part of a remedial treatment. Remedial treatments typically occur after the organic shale formation has been producing oil over an extended time period. As oil moves through the formation and into the production wellbore, solids and viscous materials are transported through the formation with lighter oils. In some cases, the solids and viscous materials are deposited in fractures and pores within the formation. Bitumen is one material that is deposited in this manner. A treatment fluid can be injected through the production wellbore and into (i) a solid matrix within the formation, (ii) a fracture within the formation, (iii) a fracture within the formation and then into the solid matrix of the formation, or (iv) a combination thereof. In this manner, the treatment fluid dissolves the bitumen that has been deposited by the production process. As the treatment fluid flows back into the production wellbore, the fluid flushes out the dissolved bitumen. The solvent may be a component of the treatment fluid used to flush out the bitumen. In illustrative embodiments, the concentration of the solvent within the remedial treatment fluid is from 0.01% to 100%. After treating the formation with the treatment fluid, recovery of oil from the formation begins again.

In some of the oilfield applications described above, the treatment fluid is pumped and injected into a far-wellbore zone of an organic shale formation. More specifically, the far-wellbore zone includes areas of the organic shale formation that are at least 100 meters (e.g., 500 meters or 1000 meters) away from a production wellbore. By treating the far-wellbore zones of the formation with treatment fluid, bitumen further away from the wellbore is dissolved and removed from the formation. Thus, the permeability of far-wellbore zones increases and oil that is further away from the production wellbore can be more easily recovered.

The treatment fluids and treatment methods described herein are not limited to removing any particular type of bitumen. For example, in some embodiments, the treatment fluids are used to dissolve and remove naturally-occurring bitumen within organic shale formations, such as in the hydraulic fracturing and EOR operations described above. In other embodiments, the treatment fluids can be used to dissolve and remove bitumen deposited by the production process, such as in the remedial operation described above.

The treatment fluid can be pumped and injected into an organic shale formation at various temperatures. For example, the treatment fluid can be heated at the surface to temperatures above 150° C. and then injected into the formation. The high temperature of the treatment fluid can help dissolve and reduce the viscosity of the bitumen within the formation. In other embodiments, the treatment fluid is not heated at the surface and enters the wellbore from the surface at temperatures below 150° C. Treatment fluids at cooler temperatures are also capable of dissolving and removing bitumen from organic shale formations.

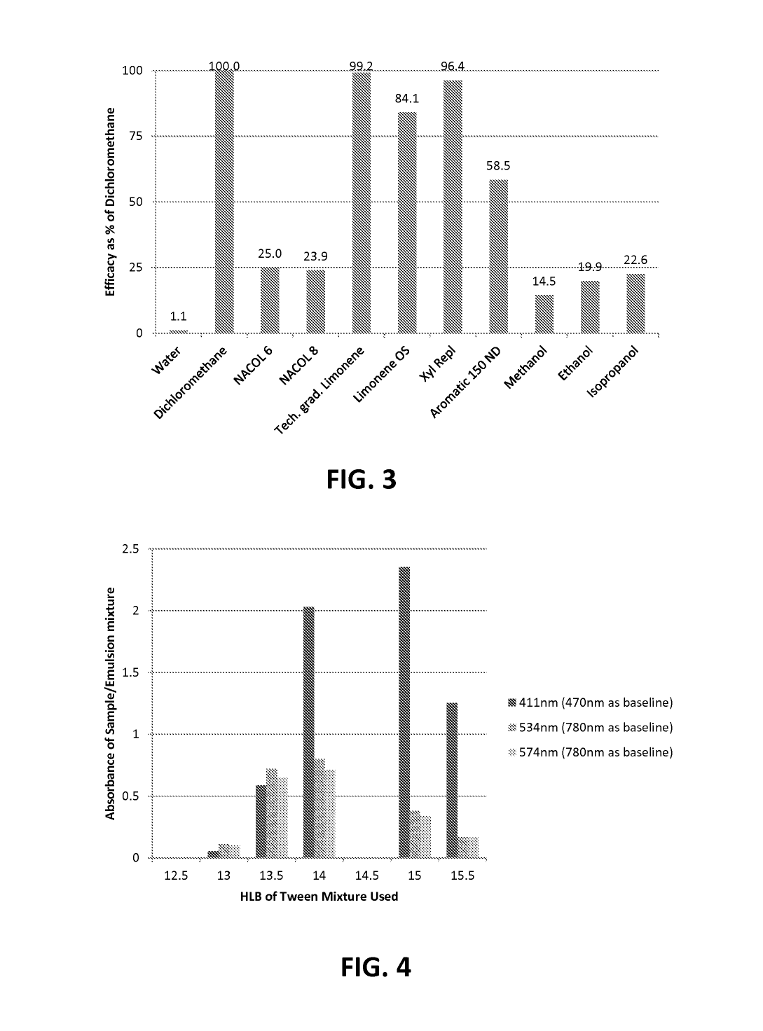

FIGS. 3-10 were generated by exposing organic shale formation samples to various treatment fluids. The formation samples were exposed to pure solvents, solvent mixtures, or solvent emulsions at 80° C. until bitumen dissolution had equilibrated. The treatment fluids (with dissolved bitumen) were then measured using visible light absorbance at 411 nm, 534 nm, and/or 574 nm. Generally, the greater the absorbance of the treatment fluid (with dissolved bitumen), the more effectively the fluid removed bitumen from the sample. The absorbance values were background-corrected using nearby lower absorbance regions at 470 nm (for 411 nm measurements) and 780 nm (for 534 nm and 574 nm measurements) to account for light scattering of emulsion droplets or suspended particles resulting in higher absorbance values.

FIG. 3 shows a plot of efficacy for various treatment fluids in dissolving bitumen in organic formation samples. The treatment fluids were composed of pure solvents. One application for a treatment fluid composed of a pure solvent is as part of a remedial treatment operation. In FIG. 3, the solvents include (i) medium-chain ethers (NACOL 6™ and NACOL 8™ from Sasol of Johannesburg, South Africa), (ii) different grades of d-limonene (TECHNICAL GRADE D-LIMONENE™ and LIMONENE OS™ from Florida Chemical, Inc., of Winter Haven, Fla.), (iii) a terpene-based xylene replacement (FC-PRO™ from Florida Chemical, Inc.), (iv) low-molecular weight alcohols (methanol, ethanol, and isopropanol), and (v) an aromatic solvent (AROMATIC 150 ND™ from ExxonMobil of Irving, Tex.). Dichloromethane was used as a positive control and water was used as a negative control. As shown in FIG. 3, the d-limonene solvents and the terpene-based xylene replacement most effectively removed bitumen from the organic formation samples.

FIGS. 4-9 were generated by exposing formation samples to different treatment fluids composed of surfactant-based emulsions. The emulsions were composed of a 5% surfactant-solvent portion and a 95% aqueous/alcohol portion by volume. TECHNICAL GRADE D-LIMONENE™ was used as the emulsified solvent. A treatment fluid with this concentration of solvent can be used as part of hydraulic fracturing operation, an EOR operation, and/or a remedial treatment.

The treatment fluids described herein can use surfactants with various hydrophilic-lipophilic balance (HLB) values. For example, a solvent in water emulsion may have an HLB value from 10.5 to 18. In a more specific embodiment, the solvent in water emulsion may have an HLB value from 13.5 to 15.5. The HLB of a surfactant is a measure of the proportion of hydrophilic to hydrophobic moieties the surfactant contains. The HLB can be matched to a given organic solvent to ensure good emulsification of that solvent in an aqueous media. FIG. 4 shows a plot of absorbance for treatment fluids composed of surfactants with different HLB values. More specifically, the figure shows bitumen dissolution for treatment fluid with a ratio of 1:2 of polysorbate and d-limonene, respectively. In each case, the polysorbate was a mixture of TWEEN 20™ and TWEEN 85™. The concentrations of TWEEN 20™ and TWEEN 85™ were varied to produce a particular HLB value. Depending on the wavelength analyzed, there are two optimal HLB values. This outcome suggests that different components in the bitumen are differentially emulsified at a particular HLB value. One optima is at an HLB value of 14 for 534 nm and 574 nm components, while the other optima is at an HLB value of 15 for the 411 nm component.

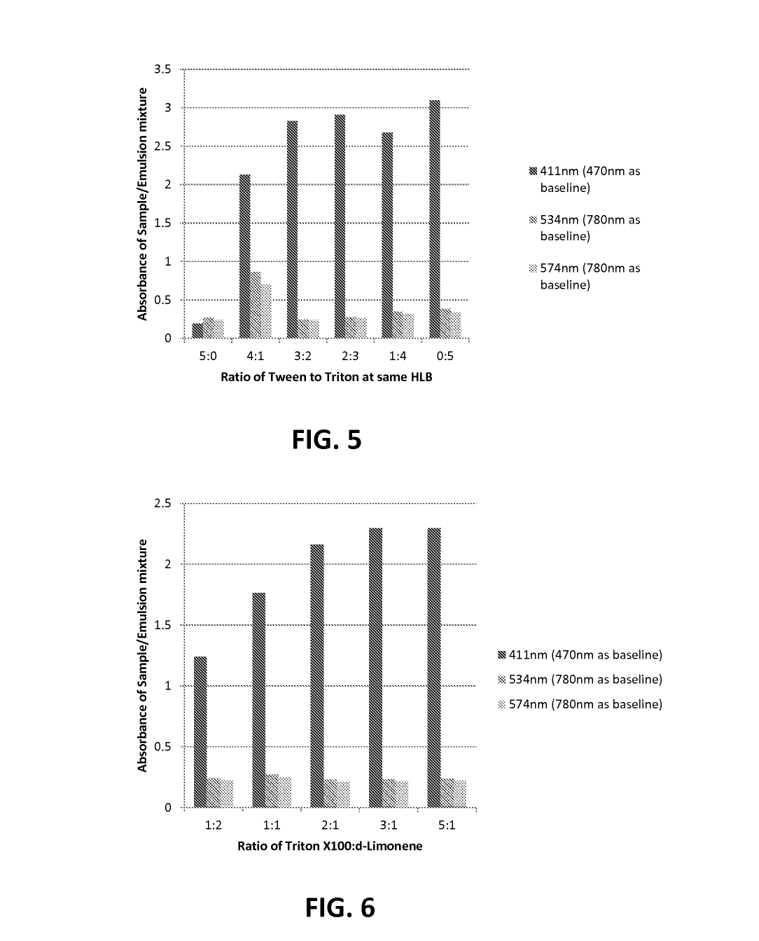

Different surfactants with the same HLB values have different abilities to emulsify the same compound. FIG. 5 shows a plot of absorbance for treatment fluids composed of a solvent and a combination of two surfactants at different ratios of the two surfactants. The surfactants include (i) a polysorbate mixture prepared at an HLB value of 13.5 and (ii) TRITON-X100™, which naturally has the same HLB value. The high absorbance values at 534 nm and 574 nm in the 4:1 sample may be due to interference from emulsion droplet light-scattering background. FIG. 5 shows that efficiency can depend on the composition of the surfactant, not just its HLB value.

The treatment fluids described herein can have different solvent-surfactant ratios. For example, for a polysorbate emulsion, solvent-surfactant ratios can be from 1:1 to 1:3. FIG. 6 shows a plot of absorbance for treatment fluids composed of emulsions with different solvent-surfactant ratios. Although higher concentrations of solvent better dissolve bitumen, higher concentrations of surfactant should better emulsify the dissolved bitumen. FIG. 6 shows that higher concentrations of surfactant best emulsify bitumen components that absorb at 411 nm, while intermediate ratios best emulsify bitumen components that absorb at 534 nm and 574 nm.

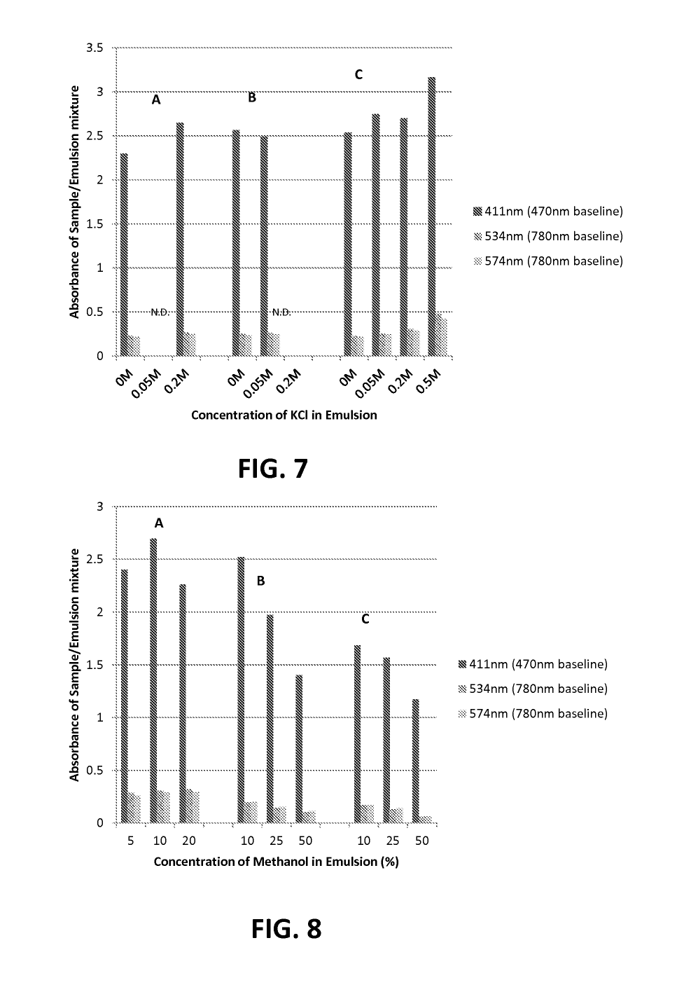

The treatment fluid described herein can have different alcohol concentrations and salinity levels to enhance emulsion stability. FIG. 7 shows a plot of absorbance for treatment fluids composed of emulsions with varying salinity equilibrated against powdered shale at 80° C. The salinity of the emulsions was varied using potassium chloride (KCL). Emulsion A included a ratio of 3:1 for TRITON X100™ and-limonene, respectively. Emulsion B included a ratio of 1:2:1 for polysorbate, TRITON X100™, and d-limonene, respectively. Emulsion C included a ratio of 3:1 for polysorbate and d-limonene, respectively. Emulsions A-C had a surfactant plus limonene content of 5% and the polysorbate was a blend of TWEEN 20™ and TWEEN 85™ with a HLB value of 14.5. Within FIG. 7, columns marked with “N.D.” could not be measured (Emulsion A at 0.05M KCl and Emulsion B at 0.2M KCl exhibited two separate liquid phases and could not be quantified). FIG. 7 shows that increases in salinity increase bitumen emulsification, but can also cause destabilization of the resulting emulsion. For this reason, in various embodiments, the amount of salt within the treatment fluid is less than 1%.

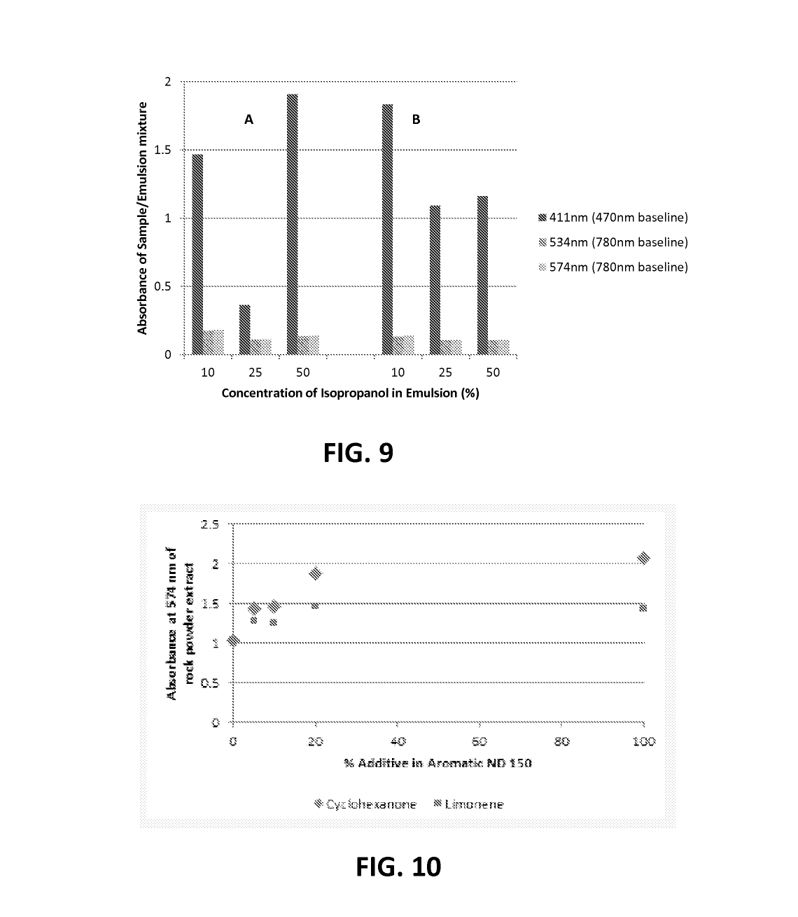

FIG. 8 shows a plot of absorbance for treatment fluids composed of emulsions with varying methanol content equilibrated against rock powder. Emulsion A included a ratio of 3:1 for polysorbate and d-limonene (with 0.2M KCl). Emulsion B included a ratio of 4:1:2.5 for TRITON X100™, polysorbate, and d-limonene, respectively. Emulsion C included a ratio of 3:1:1:2.5 for TRITON X100™, polysorbate, 1M dioctyl sodium sulfosuccinate dissolved in isopropanol, and d-limonene, respectively. The polysorbate in Emulsion A was a blend of TWEEN 20™ and TWEEN 85™ with an HLB value of 14.5. The polysorbate in Emulsions B and C was a blend of TWEEN 80™ and TWEEN 85™ with an HLB value of 13.5. FIG. 9 shows a plot of absorbance for treatment fluids composed of emulsions with varying isopropanol content equilibrated against rock powder. Emulsion A included a ratio of 4:1:2.5 for TRITON X100™, polysorbate, and d-limonene, respectively. Emulsion B included a ratio of 3:1:1:2.5 for TRITON X100™, polysorbate, 1M dioctyl sodium sulfosuccinate dissolved in isopropanol, and d-limonene, respectively. The polysorbate was a mixture of TWEEN 20™ and TWEEN 85™ with an HLB value of 13.5 in both emulsions. FIGS. 8 and 9 show that increases in alcohol content (e.g., methanol or isopropanol) decrease bitumen emulsification.

FIG. 10 shows a plot of absorbance for treatment fluids composed of solvent-solvent mixtures. The figure was generated by exposing formation samples to different treatment fluids composed of solvent-solvent mixtures. A first set of mixtures included an aromatic solvent (AROMATIC 150 ND™) with 5%, 10%, and 20% concentrations of cyclohexane. A second set of mixtures included the aromatic solvent (AROMATIC 150 ND™) with 5%, 10%, and 20% concentrations of limonene. The 0% and 100% concentrations were used as controls. FIG. 10 shows that a concentration from 5% to 20% of cyclohexane or limonene can significantly improve the performance of the aromatic fluid.

Although several example embodiments have been described in detail above, those skilled in the art will readily appreciate that many modifications are possible in the example embodiments without materially departing from the scope of this disclosure. Accordingly, all such modifications are intended to be included within the scope of this disclosure.

What is claimed is:

1. A method for treating an organic shale formation to increase permeability, the method comprising:
using a wellbore that traverses the organic shale formation to treat at least a portion of the shale formation with a treatment fluid, wherein the treatment fluid comprises a solvent that dissolves bitumen in the shale formation and increases permeability of the shale formation.

2. The method of claim 1, wherein the solvent comprises a terpene-based solvent.

3. The method of claim 2, wherein the terpene-based solvent comprises a limonene-based solvent.

4. The method of claim 2, wherein the terpene-based solvent comprises a pinene-based solvent.

5. The method of claim 1, wherein the solvent comprises one of cyclohexanone, N-methylpyrrolidinone, an aromatic fluid, a dialkyl ether, an alkylated fatty acid, a fatty acid alkyl ester, an alkenoic acid ester, 2-methyltetrahydrofuran, or a combination thereof.

6. The method of claim 1, wherein the solvent comprises a limonene-based solvent, a pinene-based solvent, cyclohexanone, N-methylpyrrolidinone, an aromatic fluid, a dialkyl ether, an alkylated fatty acid, a fatty acid alkyl ester, an alkenoic acid ester, 2-methyltetrahydrofuran, or a combination thereof.

7. The method of claim 1, wherein the treatment fluid comprises a concentration from 0.01% to 100% of the solvent.

8. The method of claim 1, wherein the treatment fluid comprises a diluent.

9. The method of claim 8, wherein the diluent comprises water and the treatment fluid comprises an emulsification of the water and the solvent

10. The method of claim 8, wherein the diluent comprises a gas-based foam.

11. The method of claim 1, wherein a portion of the shale formation that is at least 100 meter away from the wellbore is treated with solvent.

12. The method of claim 1, wherein the bitumen is naturally-occurring bitumen within the formation.

13. The method of claim 1, wherein the shale formation comprises kerogen, bitumen, and a mobile oil.

14. The method of claim 1, further comprising:
recovering oil from the shale formation after the formation is treated with solvent.

15. The method of claim 1, wherein treating the shale formation with the treatment fluid comprises:
using the treatment fluid to hydraulically fracture the portion of the organic shale formation.

16. The method of claim 1, further comprising:
after treating the portion of the organic shale formation with the treatment fluid, hydraulically fracturing the portion of the formation.

17. The method of claim 1, further comprising:
recovering oil from the portion of the organic shale formation;
after recovering oil from the portion of the shale formation, treating the portion of the shale formation with the treatment fluid; and
after treating the portion of the shale formation, recovering oil from the portion of the organic shale formation.

18. The method of claim 1, further comprising:
injecting the treatment fluid into the portion of the shale formation using an injection well; and
recovering the treatment fluid and oil at a production wellbore.

19. The method of claim 1, further comprising:
heating the treatment fluid to a temperature above 150° C. before treating the portion of the shale formation with the treatment fluid.

20. The method of claim 1, wherein the solvent does not include xylene.
